(19) United States
(12) Patent Application Publication
(10) Pub. No.: US 2019/0356677 A1
(43) Pub. Date: Nov. 21, 2019

(54) MALICIOUS WIRELESS SAFETY MESSAGE DETECTION USING AN ANGLE OF ARRIVAL

(71) Applicant: GM Global Technology Operations LLC, Detroit, MI (US)

(72) Inventors: Mohammad Naserian, Windsor (CA); Donald K. Grimm, Utica, MI (US); Allan K. Lewis, Windsor (CA)

(21) Appl. No.: 15/983,807

(22) Filed: May 18, 2018

(51) Int. Cl. H04L 29/06; H04W 4/40; H04W 24/08; H04W 12/10

(52) U.S. Cl. CPC H04L 63/1408; H04W 12/10; H04W 24/08; H04W 4/40

(57) ABSTRACT

Embodiments include methods, systems and computer readable storage medium for determining receipt of a malicious message by a vehicle. The method includes receiving, by a processor, a message and determining, by the processor, a message type associated with the message. The method includes calculating, by the processor, an angle of arrival (AoA) for the message, wherein the AoA is an angle of receipt for the message. The method includes comparing, by the processor, the AoA to a message angle, wherein the message angle is an expected angle of receipt or angle range for the message based on the message type. The method includes flagging, by the processor, the message as being malicious in response to the comparison indicating that the AoA is not equivalent to or within a predetermined tolerance of the message angle. The method includes suppressing, by the processor, a notification or warning associated with the flagged message.

### INTRODUCTION

The subject disclosure relates to vehicle safety, and more specifically to determining receipt of a malicious message by a vehicle to address vehicle safety and crash avoidance.

Autonomous vehicles are automobiles that have the ability to operate and navigate without human input. Autonomous vehicles use sensors, such as radar, LIDAR, global positioning systems, and computer vision, to detect the vehicle's surroundings. Advanced computer control systems interpret the sensory input information to identify appropriate navigation paths, as well as obstacles and relevant signage. Some autonomous vehicles update map information in real time to remain aware of the autonomous vehicle's location even if conditions change or the vehicle enters an uncharted environment. Autonomous vehicles as well as non-autonomous vehicles increasingly communicate with remote computer systems and with one another using V2X communications—Vehicle-to-Everything, Vehicle-to-Vehicle (V2V), Vehicle-to-Infrastructure (V2I)).

V2V involves a dynamic wireless exchange of data between nearby vehicles. V2V uses on-board dedicated short-range communication (DSRC) radio devices to transmit messages about a vehicle's speed, heading, brake status, and other information to other vehicles and receive the same messages from other vehicles. These messages are known as Wireless Safety Messages (WSMs). WSMs can employ a variety of formats. For example, in Europe, WSM formats used to send and receive messages are a Cooperative Awareness Message (CAM) or a Decentralized Environmental Notification Message (DENM). In North America, the WSM format used to send and receive messages is a Basic Safety Message (BSM). In China, the WSM format used to send and receive messages is a Cellular Vehicle-to-Everything (C-V2X). WSMs can be derived using non-vehicle-based technologies such as global positioning system (GPS) to detect a location and speed of a vehicle, or using vehicle-based sensor data where the location and speed data is derived from the vehicle's on-board computer. Accordingly, exchanging messages with other vehicles using V2V enables a vehicle to automatically sense the position of surrounding vehicles with 360-degree awareness as well as potential hazards present, calculate risk based on the position, speed, or trajectory of surrounding vehicles, issue driver advisories or warnings, and take pre-emptive actions to avoid and mitigate crashes.

Accordingly, it is desirable to provide a system that can detect malicious WSMs that have been spoofed by an attacker. An angle of arrival (AoA) for messages received by a vehicle can be used to eliminate and/or suppress malicious warnings sent to the vehicle.

### SUMMARY

In one exemplary embodiment, a method for determining receipt of a malicious message by a vehicle is disclosed. The method includes receiving, by a processor, a message. The method further includes determining, by the processor, a message type associated with the message. The method further includes calculating, by the processor, an angle of arrival (AoA) for the message, wherein the AoA is an angle of receipt for the message. The method further includes comparing, by the processor, the AoA to a message angle, wherein the message angle is an expected angle of receipt or angle range for the message based on the message type. The method further includes flagging, by the processor, the message as being malicious in response to the comparison indicating that the AoA is not equivalent to or within a predetermined tolerance of the message angle. The method further includes suppressing, by the processor, a notification or warning associated with the flagged message.

In addition to one or more of the features described herein, one or more aspects of the described method can additionally be related to reporting the flagged message to a monitoring system. Another aspect of the method is that the calculation of the AoA uses a physical layer of a wireless communications channel. Another aspect of the method is that a direction of a strongest signal received at an antenna associated with a vehicle receiving the message is used to estimate an angle of receipt for the message. Another aspect of the method is that the message angle varies based on the message type associated with the message. Another aspect of the method can include suppressing the notification or warning associated with the flagged message comprises preventing the notification or warning to be presented to a driver. Another aspect of the method can include suppressing the notification or warning associated with the flagged message causing an autonomous vehicle to ignore the notification or warning. Another aspect of the method is that the received message is a wireless safety message.

In another exemplary embodiment, a system for determining receipt of a malicious message by a vehicle is disclosed herein. The system includes one or more vehicles in which each vehicle includes a memory and processor and in which the processor is operable to receive a message. The processor is further operable to determine a message type associated with the message. The processor is further operable to calculate an angle of arrival (AoA) for the message, wherein the AoA is an angle of receipt for the message. The processor is further operable to compare the AoA to a message angle, wherein the message angle is an expected angle of receipt or angle range for the message based on the message type. The processor is further operable to flag the message as being malicious in response to the comparison indicating that the AoA is not equivalent to or within a predetermined tolerance of the message angle. The processor is further operable to suppress a notification or warning associated with the flagged message.

In yet another exemplary embodiment a computer readable storage medium for determining receipt of a malicious message by a vehicle is disclosed herein. The computer readable storage medium includes receiving a message. The computer readable storage medium further includes determining a message type associated with the message. The computer readable storage medium further includes calculating an angle of arrival (AoA) for the message, wherein the AoA is an angle of receipt for the message. The computer readable storage medium further includes comparing the AoA to a message angle, wherein the message angle is an expected angle of receipt or angle range for the message based on the message type. The computer readable storage medium further includes flagging the message as being malicious in response to the comparison indicating that the AoA is not equivalent to or within a predetermined tolerance of the message angle. The computer readable storage medium further includes suppressing a notification or warning associated with the flagged message.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a computing environment according to one or more embodiments;

FIG. 2 is a block diagram illustrating one example of a processing system for practice of the teachings herein;

FIG. 3 depicts an interaction between one or more vehicles and an attacker according to one or more embodiments; and

FIG. 4 depicts a flow diagram of a method for determining receipt of a malicious message by a vehicle according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

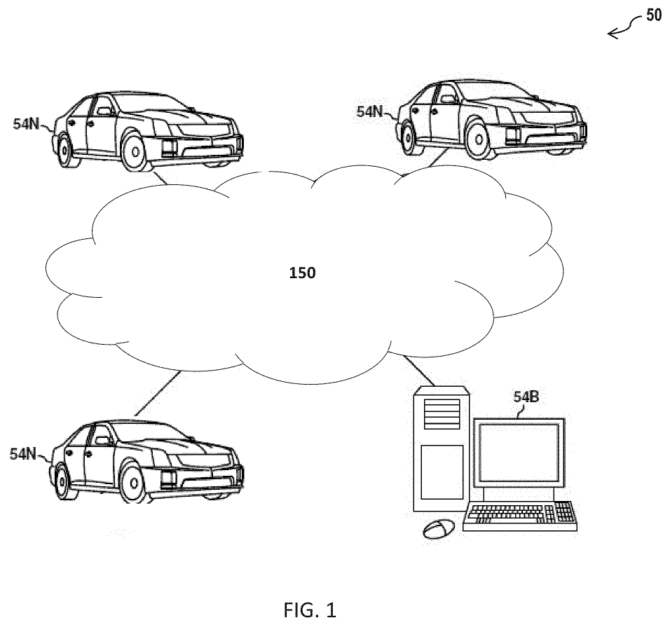

In accordance with an exemplary embodiment, FIG. 1 illustrates a computing environment 50 associated with a system for malicious wireless safety message detection using an angle of arrival. As shown, computing environment 50 comprises one or more computing devices, for example, a server 54B, and/or a plurality of automobile onboard computer systems 54N, each associated with an autonomous or non-autonomous vehicle, which is connected via network 150. The one or more computing devices can communicate with one another using network 150.

Network 150 can be, for example, a cellular network, a local area network (LAN), a wide area network (WAN), such as the Internet, a dedicated short range communications network (for example, V2V communication (vehicle-to-vehicle), V2X communication (i.e., vehicle-to-everything), V2I communication (vehicle-to-infrastructure), and V2P communication (vehicle-to-pedestrian)), or any combination thereof, and may include wired, wireless, fiber optic, or any other connection. Network 150 can be any combination of connections and protocols that will support communication between server 54B, and/or the plurality of vehicle on-board computer systems 54N, respectively.

Each of the plurality of vehicle on-board computer systems 54N can include a GPS transmitter/receiver (not shown) which is operable for receiving location signals from the plurality of GPS satellites (not shown) that provide signals representative of a location for each of the mobile resources, respectively. In addition to the GPS transmitter/receiver, each vehicle associated with one of the plurality of vehicle on-board computer systems 54N may include a navigation processing system that can be arranged to communicate with a server 54B through the network 150. Accordingly, each vehicle associated with one of the plurality of vehicle on-board computer systems 54N is able to determine location information and transmit that location information to the server 54B or another vehicle on-board computer system 54N.

Additional signals sent and received may include data, communication, and/or other propagated signals. Further, it should be noted that the functions of transmitter and receiver can be combined into a signal transceiver.

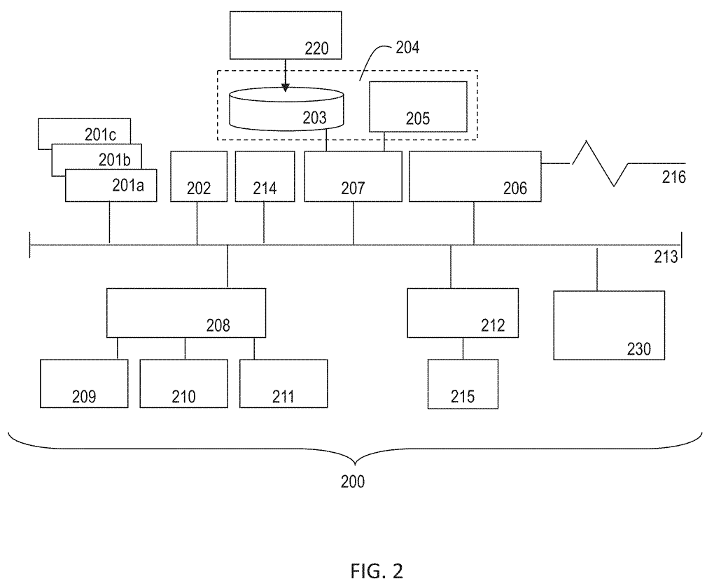

In accordance with an exemplary embodiment, FIG. 2 illustrates a processing system 200 for implementing the teachings herein. The processing system 200 can form at least a portion of the one or more computing devices, such as the server 54B, and/or each of the plurality of vehicle on-board computer systems 54N. The processing system 200 may include one or more central processing units (processors) 201a, 201b, 201c, etc. (collectively or generically referred to as processor(s) 201). Processors 201 are coupled to system memory 214 and various other components via a system bus 213. Read only memory (ROM) 202 is coupled to the system bus 213 and may include a basic input/output system (BIOS), which controls certain basic functions of the processing system 200.

FIG. 2 further depicts an input/output (I/O) adapter 207 and a network adapter 206 coupled to the system bus 213. I/O adapter 207 may be a small computer system interface (SCSI) adapter that communicates with a hard disk 203 and/or other storage drive 205 or any other similar component. I/O adapter 207, hard disk 203, and other storage device 205 are collectively referred to herein as mass storage 204. Operating system 220 for execution on the processing system 200 may be stored in mass storage 204. The network adapter 206 interconnects bus 213 with an outside network 216 enabling data processing system 200 to communicate with other such systems. A screen (e.g., a display monitor) 215 can be connected to system bus 213 by display adaptor 212, which may include a graphics adapter to improve the performance of graphics intensive applications and a video controller. In one embodiment, adapters 207, 206, and 212 may be connected to one or more I/O busses that are connected to system bus 213 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 213 via user interface adapter 208 and display adapter 212. A keyboard 209, mouse 210, and speaker 211 can all be interconnected to bus 213 via user interface adapter 208, which may include, for example, a Super I/O chip integrating multiple device adapters into a single integrated circuit.

The processing system 200 may additionally include a graphics-processing unit 230. Graphics processing unit 230 is a specialized electronic circuit designed to manipulate and alter memory to accelerate the creation of images in a frame buffer intended for output to a display. In general, graphics-processing unit 230 is very efficient at manipulating computer graphics and image processing, and has a highly parallel structure that makes it more effective than general-purpose CPUs for algorithms where processing of large blocks of data is done in parallel.

Thus, as configured in FIG. 2, the processing system 200 includes processing capability in the form of processors 201, storage capability including system memory 214 and mass storage 204, input means such as keyboard 209 and mouse 210, and output capability including speaker 211 and display 215. In one embodiment, a portion of system memory 214 and mass storage 204 collectively store an operating system to coordinate the functions of the various components shown in FIG. 2.

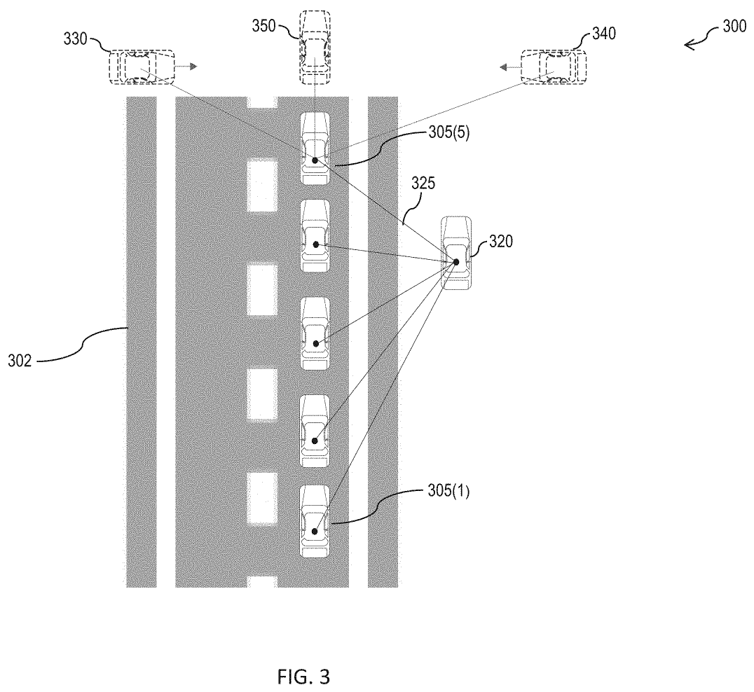

FIG. 3 depicts an attack 300 on a vehicle on-board computer system of a vehicle using malicious wireless safety messages (WSMs) according to one or more embodiments. As a vehicle, for example, vehicle 305, travels along a road network 302 from position 305(1) to position 305(5), the vehicle 305 can receive a variety of information, which can be used to assist in the operation of the vehicle 305. For example, vehicles traveling along the road network 302 can use vehicle-to-vehicle communications (V2V) to provide status information for an associated vehicle. The status information can be related to, for example, a particular vehicle's speed, heading, location, braking status, environmental data such as road conditions, and other information relating to a vehicle's state and predicted path.

In addition, the vehicle 305 can receive a variety of WSMs from other vehicles traveling along the road network 302. The WSMs can be received and interpreted by an automobile onboard computer system 54N of vehicle 305. The WSMs can be messages related to vehicle safety/crash avoidance.

For example, the vehicle 305 can receive an intersection collision warning (ICW), which is a warning intended to indicate an impending collision with another vehicle at an upcoming intersection. The vehicle 305 can receive a forward collision warning (FCW), which is a warning intended to indicate an impending collision with a vehicle in front of vehicle 305. The vehicle 305 can receive an emergency electronic brake light warning (EEBL), which is a warning indicating a quick deceleration of a vehicle ahead, but not directly ahead of vehicle 305. The vehicle 305 can receive a stationary vehicle alert (SVA), which is a warning intended to indicate a stopped or slow vehicle ahead. These WSMs may be provided to a driver of vehicle 305 in order for the driver to prevent a crash, or, in an autonomous vehicle scenario, the automobile onboard computer system 54N of vehicle 305 can use received WSMs to prevent a crash.

While the intent of WSMs is for vehicle safety/crash avoidance, unscrupulous individuals may attempt to use WSMs to cause crashes by sending false/incorrect warnings to an unsuspecting vehicle, i.e., an attack. In the attack 300, an attacker located in a vehicle 320 (attacker need not be in a vehicle) can attempt to cause an accident involving vehicle 305 by sending vehicle 305 false/spoofed WSMs. Another potential attack 300 could involve causing an unrelated vehicle to send erroneous location information (e.g., modify the system to report GPS location that is always offset by 10 meters or 50 meters) in an attempt to cause an accident.

For example, when vehicle 305 is located at location 305(5) and entering an intersection under a green light, the attacker 320 can send vehicle 305 an ICW WSM even though there is no cross-traffic entering the intersection. Receiving an ICW WSM in this instance can cause extreme braking by vehicle 305. The extreme braking by vehicle 305 can cause a vehicle traveling behind vehicle 305 to crash into vehicle 305 due to an unexpected braking event by vehicle 305. A similar scenario can result from the attacker 320 sending vehicle 305 an EEBL WSM along a road network.

Verifying that received WSMs are genuine is difficult. For example, when attacked by attacker 320, the vehicle 305 can falsely conclude that the ICW WSM was sent by vehicle 330 or vehicle 340, which is not an actual vehicle at an upcoming intersection. In response to an EEBL or SVA WSM, the vehicle 305 can falsely conclude that the EEBL WSM was sent by vehicle 350.

In light of the mentioned difficulties of confirming that receipt of a WSM is proper, one or more embodiments disclosed herein can take into account angles of receipt of WSMs received (i.e. angle of arrival (AoA)), as well as intended angles associated with a particular WSM (WSM angle). The WSM angle can be compared to AoA in order to confirm that a particular WSM is received from an angle for which the particular WSM should be received.

The AoA can be determined using a physical layer of a wireless communications channel. The physical layer can be used to send WSMs from vehicle 305, as well as receive WSMs at the vehicle 305. Communications of WSMs associated with vehicle 305 can be used to estimate a position of the vehicle 305. The physical layer can also be used to correlate an estimated angle of message receipt for each WSM received at an antenna of the vehicle 305 based on received signal strength.

As vehicle 305 is traveling from position 305(1) to 305(5), the automobile onboard computer system 54N of vehicle 305 can compare an AoA for a received message sent by attacker 320 to a WSM angle for a message type associated with the received message. For example, while approaching an intersection at position 305(5), the vehicle 305 can receive an ICW WSM from attacker 320. The automobile onboard computer system 54N of vehicle 305 can estimate an angle of message receipt for the received ICW WSM 325 (AoA) based on a received signal strength which is determined using a wireless communications channel physical layer associated with the vehicle 305. For example, when the vehicle 305 is at position 305(5), the AoA for the ICW WSM sent by attacker 320 can be estimated at approximately 120 degrees to 140 degrees.

Given that, an ICW WSM should be sent from a vehicle (e.g., vehicle 330 or vehicle 340) ahead of vehicle 305 and to either side of the vehicle 305, an expected WSM angle for the ICW WSM can range from for example, 270 degrees to 90 degrees. The automobile onboard computer system 54N of vehicle 305 can compare the AoA for the received ICW WSM (e.g., 130 degrees) to the expected WSM angle of the ICW WSM (270 degrees to 90 degrees). Since the ICW WSM sent by the attacker 320 does not fall within an expected range associated with WSM angle associated with an ICW WSM, the automobile onboard computer system 54N of vehicle 305 can flag the received ICW WSM as a malicious message. Accordingly, the automobile onboard computer system 54N of vehicle 305 can report that a malicious attack has occurred, along with the associated WSM and location information to a vehicle/road network monitoring system, for example, server 54B. The automobile onboard computer system 54N of vehicle 305 can also suppress/ignore the flagged ICW WSM, thereby preventing a notification/warning to be issued to a driver of the vehicle 305 or preventing an autonomous vehicle from taking action in response to the flagged ICW WSM.

As previously mentioned, the attacker 320 need not be stationary in order for a malicious attack determination to occur. For example, the attacker 320 can be traveling in a direction parallel to vehicle 305. The automobile onboard computer system 54N of vehicle 305 can estimate a speed of a vehicle associated with the attacker 320 to determine an AoA for a WSM received by the vehicle 305.

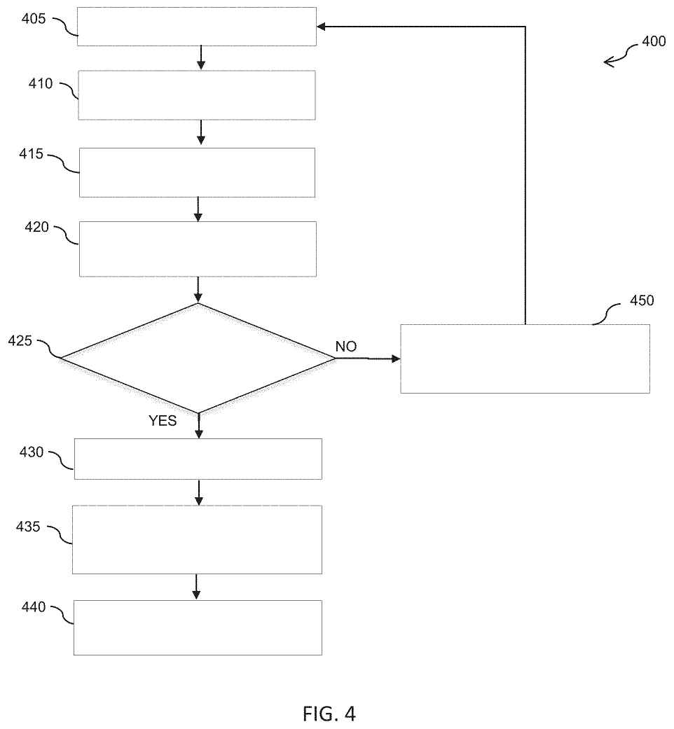

In accordance with an exemplary embodiment, FIG. 4 depicts a flow diagram of a method 400 for determining receipt of a malicious wireless safety message (WSM) by a vehicle according to one or more embodiments. At block 405, a vehicle can receive one or more wireless safety messages (WSM). At block 410, an automobile onboard computer system of a vehicle receiving the WSM can examine the WSM to determine a message type (e.g., ICW, EEBL, FCW, etc.). At block 415, an angle of attack (AoA) can be calculated by the automobile onboard computer system of the vehicle using a physical layer of a communications channel to determine a direction of message receipt and a strongest signal associated with the received message. At block 420, the AoA can be compared to an expected angle or angle range of receipt for the type of message received (WSM angle).

At block 425, the method 400 can determine if the AoA equals or is within the angle range associated with the WSM angle for the received message. A tolerance can also be added to the WSM angle to limit false positives. If the AoA is within the WSM angle/range and associated tolerance, the method 400 proceeds to block 450 where the automobile onboard computer system of the vehicle can issue a warning/notification to a driver based on the WSM, or in an autonomous vehicle scenario, the autonomous vehicle can act in response to the WSM. After block 450, the method 400 returns to block 405.

If the AoA falls outside the WSM angle/range and associated tolerance, the method 400 proceeds to block 430 where the received WSM is flagged as being malicious. At block 435, the flagged WSM can be suppressed to prevent the vehicle from issuing a false notification/warning to a driver based on the malicious WSM. Accordingly, the driver is not goaded into rash driving in response to false/ghost messages, which could lead to an accident. Also, in an autonomous vehicle scenario, the autonomous vehicle can ignore the flagged WSM. At block 440, the flagged WSM can be reported to a vehicle/road network monitoring system, for example server 54B, for further review.

Accordingly, the embodiments disclosed herein describe a system that uses an AoA estimation created using a physical layer of a wireless channel to estimate a position of the target vehicle (vehicle receiving a wireless safety message (WSM)) and compare the estimated position with the claimed position of a transmitting vehicle (i.e. a location or angle of where a message should have been sent based on the message type) that is sent with the wireless message. If there is discrepancy over time based on the change in location of the target vehicle and the claimed position of the transmitting vehicle, the transmitting vehicle is determined to be a malicious attacker and all the warnings caused by the received WSM should be suppressed.

It is understood that although the embodiments are described as being implemented on a traditional processing system, the embodiments are capable of being implemented in conjunction with any other type of computing environment now known or later developed. For example, the present techniques can be implemented using cloud computing. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. It should be appreciated that the computing environment 50 that is associated with determining receipt of a malicious wireless safety message (WSM) by a vehicle can be implemented in a cloud computing environment, and reports that a malicious attack has occurred, the associated WSM and location information can be stored locally and/or remotely, such as in the cloud computing environment.

Technical effects and benefits of the disclosed embodiments include, but are not limited to reducing the potential for a driver to receive false and malicious notifications or warnings that could cause the driver to perform rash actions that could lead to an accident.

The present disclosure may be a system, a method, and/or a computer readable storage medium. The computer readable storage medium may include computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a mechanically encoded device and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for determining receipt of a malicious message by a vehicle, the method comprising:
receiving, by a processor, a message;
determining, by the processor, a message type associated with the message;
calculating, by the processor, an angle of arrival (AoA) for the message, wherein the AoA is an angle of receipt for the message;
comparing, by the processor, the AoA to a message angle, wherein the message angle is an expected angle of receipt or angle range for the message based on the message type;
flagging, by the processor, the message as being malicious in response to the comparison indicating that the AoA is not equivalent to or within a predetermined tolerance of the message angle; and
suppressing, by the processor, a notification or warning associated with the flagged message.

2. The method of claim 1, further comprising reporting the flagged message to a monitoring system.

3. The method of claim 1, wherein the calculation of the AoA uses a physical layer of a wireless communications channel.

4. The method of claim 1, wherein a direction of a strongest signal received at an antenna associated with a vehicle receiving the message is used to estimate an angle of receipt for the message.

5. The method of claim 1, wherein the message angle varies based on the message type associated with the message.

6. The method of claim 1, wherein suppressing the notification or warning associated with the flagged message comprises preventing the notification or warning to be presented to a driver.

7. The method of claim 1, wherein suppressing the notification or warning associated with the flagged message comprises causing an autonomous vehicle to ignore the notification or warning.

8. The method of claim 1, wherein the received message is a wireless safety message.

9. A system for determining receipt of a malicious message by a vehicle, the system comprising:
one or more vehicles, wherein each vehicle comprises:
a memory; and
one or more processors coupled to the memory, wherein the one or more processors are operable to:
receive a message;
determine a message type associated with the message;
calculate an angle of arrival (AoA) for the message, wherein the AoA is an angle of receipt for the message;
compare the AoA to a message angle, wherein the message angle is an expected angle of receipt or angle range for the message based on the message type;
flag the message as being malicious in response to the comparison indicating that the AoA is not equivalent to or within a predetermined tolerance of the message angle; and
suppress a notification or warning associated with the flagged message.

10. The system of claim 9, further comprising reporting the flagged message to a monitoring system.

11. The system of claim 9, wherein the calculation of the AoA uses a physical layer of a wireless communications channel.

12. The system of claim 9, wherein a direction of a strongest signal received at an antenna associated with a vehicle receiving the message is used to estimate an angle of receipt for the message.

13. The system of claim 9, wherein the message angle varies based on the message type associated with the message.

14. The system of claim 9, wherein suppressing the notification or warning associated with the flagged message comprises preventing the notification or warning to be presented to a driver.

15. The system of claim 9, wherein suppressing the notification or warning associated with the flagged message comprises causing an autonomous vehicle to ignore the notification or warning.

16. The system of claim 9, wherein the received message is a wireless safety message.

17. A non-transitory computer readable storage medium having program instructions embodied therewith, the program instructions readable by a processor to cause the processor to perform a method for determining receipt of a malicious message by a vehicle comprising:
receiving a message;
determining a message type associated with the message;
calculating an angle of arrival (AoA) for the message, wherein the AoA is an angle of receipt for the message;
comparing the AoA to a message angle, wherein the message angle is an expected angle of receipt or angle range for the message based on the message type;
flagging the message as being malicious in response to the comparison indicating that the AoA is not equivalent to or within a predetermined tolerance of the message angle; and
suppressing a notification or warning associated with the flagged message.

18. The computer readable storage medium of claim 17, wherein the calculation of the AoA uses a physical layer of a wireless communications channel.

19. The computer readable storage medium of claim 17, wherein suppressing the notification or warning associated with the flagged message comprises preventing the notification or warning to be presented to a driver.

20. The computer readable storage medium of claim 17, wherein suppressing the notification or warning associated with the flagged message comprises causing an autonomous vehicle to ignore the notification or warning.
